(19) United States
(12) Patent Application Publication
(10) Pub. No.: US 2008/0244501 A1
(43) Pub. Date: Oct. 2, 2008

(54) METHOD FOR READING INFORMATION FROM A HIERARCHICAL DESIGN

(75) Inventors: Warren E. Davison, Austin, TX (US); John F. Mullen, Rochester, MN (US); George R. Zettles, Rochester, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/695,461

(22) Filed: Apr. 2, 2007

(51) Int. Cl. G06F 17/50

(52) U.S. Cl. 716/18

(57) ABSTRACT

The present invention relates to a method for obtaining physical component information that is associated with hierarchical and non-hierarchical symbols as represented within a logical schematic diagram. The method comprises extracting logical design data of a hierarchical schematic from a primary software application, identifying a hierarchical symbol for analysis, and determining at least one physical component that is comprised within a schematic diagram that is represented by the identified hierarchical symbol. The method further comprises determining a schematic diagram page and path that is associated with the determined at least one physical component, determining schematic diagram children pages and paths that are associated with a common parent page and path of the at least one physical component, determining the schematic diagram parent page and path of the at least one physical component.

### BACKGROUND OF THE INVENTION

1. Field of the Invention

This invention relates to the extraction of logical design information from a design schematic, and particularly to the extraction of hierarchal design information from a logical design schematic creating application.

2. Description of Background

Before our invention, traditionally, the only means by which to extract logical design information from a hierarchical schematic was to transform the hierarchical schematic into a physical representation of the hierarchical schematic. Further available logical design extraction methods were designed for use only with flat schematic designs and therefore were not configured to work with hierarchical designs. Thus, no methods were available that allowed for the accurate extraction of logical design information from a hierarchical schematic design.

Logical design information that is extracted from a hierarchical schematic can subsequently be used as input data for an assortment of business related applications (e.g., preliminary bill-of-materials, part review reports, physical versus logical bill of material comparisons, and schematic reviews). However, the strict reliance upon information that has been obtained from a physical representation of a hierarchical schematic presents a variety of potential obstacles that may hinder product development cycles. Physical symbols are not needed to determine a logical layout for a schematic. In particular, physical symbols often require a significantly greater amount of time to complete than logical symbols. This is mainly due to the requirement that each dimension for a physical symbol must be defined, wherein a logical symbol only illustrates the pin names for a particular component. Therefore, work being performed upon a particular design can progress with logical symbols while the physical symbols are being created for the design. Also, while the physical symbols for a schematic are being created for a design a designer can extract information from the design logic that can be used to generate a bill-of-materials in addition to other information regarding required parts and design aspects of a project in order to start the procurement of necessary design components.

Therefore, there is a need for a logical design information methodology for extracting information from a schematic, wherein the extracted information can be utilized to assist in the design project review and component procurement procedures.

### SUMMARY OF THE INVENTION

The shortcomings of the prior art are overcome and additional advantages are provided through the provision of a method for obtaining physical component information that is associated with hierarchical and non-hierarchical symbols as represented within a logical schematic diagram. The method comprises extracting logical design data of a hierarchical schematic from a primary software application, identifying a hierarchical symbol for analysis, and determining at least one physical component that is comprised within a schematic diagram that is represented by the identified hierarchical symbol. The method further comprises determining a schematic diagram page and path that is associated with the determined at least one physical component, determining schematic diagram children pages and paths that are associated with a common parent page and path of the at least one physical component, determining the schematic diagram parent page and path of the at least one physical component; and saving the schematic diagram child page and path information and the schematic diagram parent page and path information of the at least one physical component into a predetermined format.

A computer program product corresponding to the above-summarized method is also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIGS. 1A and 1B illustrates examples of flow diagrams detailing the flow for determining the page and path for a part and the children pages and paths for a part.

FIG. 2 illustrates one example of aspects of the present invention for utilization to provide extracted logical design information to a software application.

The detailed description explains the preferred embodiments of the invention, together with advantages and features, by way of example with reference to the drawings.

### DETAILED DESCRIPTION OF THE INVENTION

One or more exemplary embodiments of the invention are described below in detail. The disclosed embodiments are intended to be illustrative only since numerous modifications and variations therein will be apparent to those of ordinary skill in the art.

The present invention relate to a methodology for the accurate extraction of the design information from a hierarchical schematic diagram. This method operates independent of the physical design of the hierarchical schematic diagram, and as such can be interchanged between hierarchical and flat schematic designs. The advantages of the present invention result in faster project development cycles and the early detection of any project part shortages.

Aspects of the present invention are carried out within a computing system environment. The computer system as operated by a system user can embody a conventional personal computer system on which an application that is configured to accomplish the objectives of the present methodologies is operating. As is conventional, the computer system also includes other hardware and software elements that are conventionally included in personal computer systems.

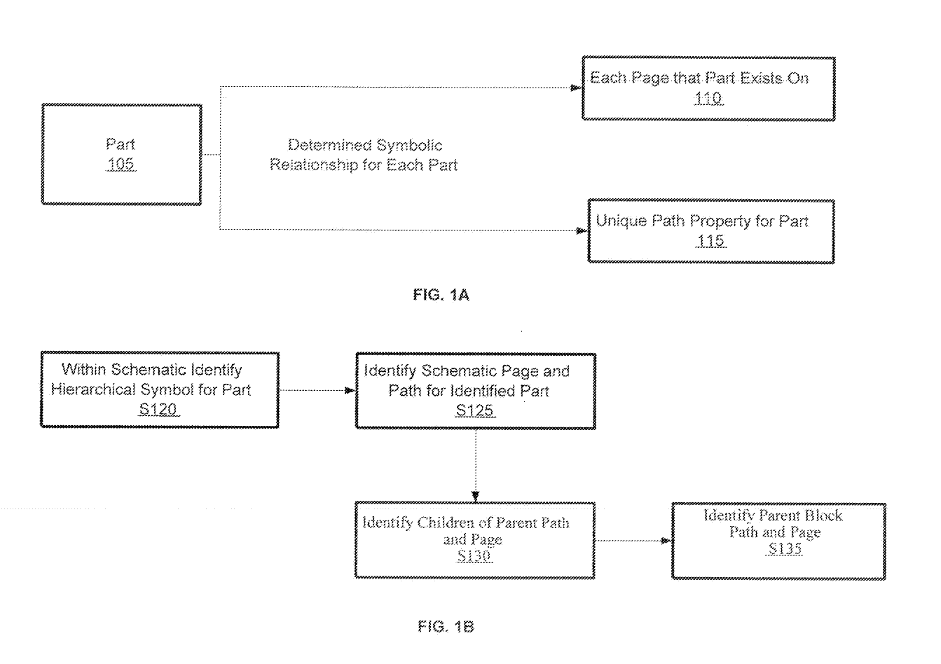

Within an electronic schematic diagram the differing component parts of the electronic schematic of a particular design are represented as standardized symbols, with power and signal connections between the components also being represented. As illustrated in FIG. 1, within a hierarchical electronic schematic diagram each symbol that represents a component part 105 that is comprised within an illustrated design has a unique page number 110 and a unique path property 115 that is comprised within the page number. Further, for each new page of the hierarchical schematic on which a symbol is represented the path property for the symbol is reset from the previous page. This relationship between symbol, page number, and path property applies to hierarchical symbols as well as non-hierarchical symbols. Within aspects of the present invention the relationships between symbol and its associated page numbers and path properties are exploited to determine the number occurrences a particular symbol has within a particular design schematic diagram.

However, the above-stated relationship between the symbol, page number, and path property is not sufficient to determine how many times that a particular symbol occurs in a schematic diagram. The reason being is that each symbol of a hierarchical schematic design is regarded as a unique schematic that comprises its own pages and path properties. Further, for any given schematic there can be two or more symbols on a page that have identical paths. To remedy this event, within aspects of the present invention, each of the symbols in a hierarchical schematic diagram is logically linked to its respective page and path property information.

It will be seen that in FIG. 1A there is a flow for extracting the data from the logics of a hierarchical design. This methodology is extremely robust in that it allows a designer to analyze a nth degree hierarchical design schematic diagram. At step 120, the hierarchical symbol for a particular component part is determined. Next, at step 125, the schematic page and the path property for the symbol on this page is determined. At step 130, all of the children pages and the path properties that are associated with the symbol are determined. Last, at step 135, the parent, or root level page and path property for the symbol are determined.

As mentioned above, by identifying the association between a symbols parent and children pages and path properties the present invention allows for the extraction of data from the logical design information of any hierarchical design schematic. Further, within aspects of the present invention the determined component part hierarchical schematic information can be saved in a predetermined format delivered for further processing to an additional processing application within a design project implementation network. For example, extracted component part information could be delivered for further processing to applications such as a bill of material generation, an automation of similar parts, an early part procurement, a part table file generation, or any other application program based upon aspects of a schematic design.

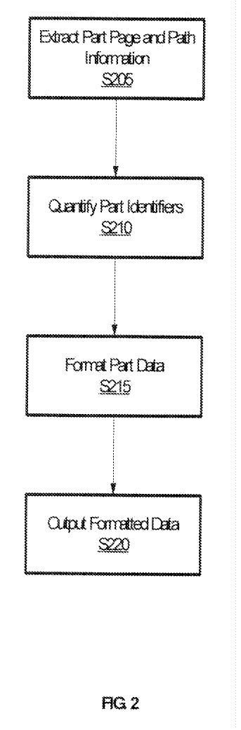

FIG. 2 shows a flow diagram illustrating aspects of how logical design information is extracted from a schematic design. At step 205, the page and path properties for a predetermined component part symbol are extracted from a hierarchical design application. At step 210, the parent and children page numbers and path properties for the component part symbol are determined. Next, at step 215, the acquired component part symbol's parent and children page numbers and path properties information is saved in a predetermined format. Last, at step 220, the formatted data is output (e.g., delivered to an application for further processing, displayed at a display device, etc.).

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed:

1. A method for obtaining physical component information that is associated with hierarchical and non-hierarchical symbols as represented within a logical schematic diagram, the method comprising:
extracting logical design data of a hierarchical schematic from a primary software application;
identifying a hierarchical symbol for analysis;
determining at least one physical component that is comprised within a schematic diagram that is represented by the identified hierarchical symbol;
determining a schematic diagram page and path that is associated with the determined at least one physical component;
determining schematic diagram children pages and paths that are associated with a common parent page and path of the at least one physical component;
determining the schematic diagram parent page and path of the at least one physical component; and
saving the schematic diagram child page and path information and the schematic diagram parent page and path information of the at least one physical component into a predetermined format.

2. The method of claim 1, further comprising inputting the formatted schematic diagram page and path information of the at least one physical component to a secondary software application.

3. A computer program product that includes a computer readable medium useable by a processor, the medium having stored thereon a sequence of instructions which, when executed by the processor, causes the processor to obtain physical component information that is associated with hierarchical and non-hierarchical symbols as represented within a logical schematic diagram, wherein the physical component information is obtained by:
extracting logical design data of a hierarchical schematic from a primary software application;
identifying a hierarchical symbol for analysis;
determining at least one physical component that is comprised within a schematic diagram that is represented by the identified hierarchical symbol;
determining a schematic diagram page and path that is associated with the determined at least one physical component;
determining schematic diagram children pages and paths that are associated with a common parent page and path of the at least one physical component;
determining the schematic diagram parent page and path of the at least one physical component; and
saving the schematic diagram child page and path information and the schematic diagram parent page and path information of the at least one physical component into a predetermined format.

4. The computer program product of claim 3, further comprising the computer program product inputting the formatted schematic diagram page and path information of the at least one physical component to a secondary software application.
